(19) United States
(12) Patent Application Publication
(10) Pub. No.: US 2012/0243104 A1
(43) Pub. Date: Sep. 27, 2012

(54) Head-up Display

(75) Inventors: Cheng-Huan Chen, Taoyuan County (TW); Wen-Wei Yang, Changhua County (TW)

(73) Assignee: NATIONAL TSING HUA UNIVERSITY, Hsinchu (TW)

(21) Appl. No.: 13/410,053

(22) Filed: Mar. 1, 2012

(30) Foreign Application Priority Data
Mar. 21, 2011 (TW) 100109485

(51) Int. Cl. G02B 27/01

(52) U.S. Cl. 359/633; 359/630

(57) ABSTRACT

The present invention discloses a head-up display (HUD) comprising an image display element, a plurality of light sources and a set of light guide components, wherein after a light beam of each light source is projected into the set of light guide components, paths of all light beams are regulated by the light guide components to deflect and concentrate at a driver's viewing range to enhance the light intensity of each light beam, and each area of the image display element is illuminated by a portion of the light sources only, so as to reduce the quantity of required light sources and achieve an overall light and thin effect of the head-up display (HUD).

### BACKGROUND OF THE INVENTION

1. Field of the Invention

The present invention relates to a head-up display (HUD), in particular to the head-up display (HUD) capable of projecting all light sources to a driver to reduce power consumption and the quantity of required light sources.

2. Description of the Related Art

In recent years, driving safety and environment are taken into consideration, and accessories for improving the reliability of motor vehicles and the visibility of drivers have gradually become popular. For example, Global Positioning System (GPS) and Head-Up Display (HUD) are common automobile accessories.

The head-up display (HUD) can simulate images to be projected onto a windshield to provide related driving information such as the status of a dashboard and navigation information. Since the drivers need not to look down or turn their head in order to view the images, therefore the drivers' vision can be concentrated to the front and their attention will not be distracted easily.

There are various types of head-up displays (HUD), and one of them uses a non-self-luminous display such as a Liquid Crystal Display (LCD) for displaying the images, and a backlight module such as a light emitting diode (LED) array to project images and reflect them onto a viewing range of the driver. This type of conventional backlight modules emits a light source divergently, so that passengers other than the driver can view the image from different angles. However, the path of each emitted light source is not concentrated, so that the intensity of a single light source projected to the driver is reduced, and it is necessary to increase the quantity of light sources before the brightness of the images can meet the expected value. On the other hand, the increased light sources will incur heavier weight, greater power consumption and higher heat dissipation requirement of the head-up display (HUD).

To reduce the volume, weight, cost, heat source, and power loss of the HUD, the inventor of the present invention provides an improved head-up display (HUD). With reference to FIG. 1 for a cross-sectional view of a conventional head-up display (HUD), the conventional head-up display (HUD) A is divided into a plurality of grids A1, wherein each grid A1 has a plurality of LEDs A2 disposed at the bottom of the grid A1, and a lens array A3 disposed at the top of the LED A2, a grid reflector A4 installed between the grids A1, a diffusion screen A5 covered on the surface of the grids A1, and an LCD A6. This device can improve the focusing of the light source to enhance the brightness of the light source and reduce the quantity of required light sources, so as to achieve the aforementioned light, thin, short and compact design. Since only the driver needs to view the images of the head-up display (HUD) and other passengers need not to view the image, therefore the conventional head-up display (HUD) A still requires further improvements.

In view of the aforementioned problem, it is necessary to provide a novel head-up display (HUD) to reduce the overall weight of the HUD to achieve the light, thin, short and compact design, and also to achieve the effects of reducing the power consumption, saving electric energy, and decreasing the burden of the car.

### SUMMARY OF THE INVENTION

Therefore, it is a primary objective of the present invention to provide a head-up display (HUD) with an improved structure capable of reducing the overall weight, achieving the light, thin, short and compact design, and decreasing the power consumption to save electric energy and lower the burden of the car.

To achieve the aforementioned objective, the present invention provides a head-up display (HUD), comprising: an image display element, for forming an image to be displayed; a plurality of light sources, disposed on a side of the image display element, and each light source providing and projecting a light beam onto the image display element, such that the image to be displayed can be projected to the outside; and a set of light guide components, installed between the image display element and the plurality of light sources; thereby, after each light source projects the light beam into the set of light guide components, paths of all light beams are regulated by the light guide components and deflected and concentrated at a viewing range of a driver to elevate the light intensity of each light beam, and each area of the image display element is projected by a portion of the light sources only, so as to decrease the quantity of required light sources and achieve an overall light and thin effect.

### BRIEF DESCRIPTION OF THE DRAWINGS

FIG. 1 is a cross-sectional view of a conventional head-up display (HUD);

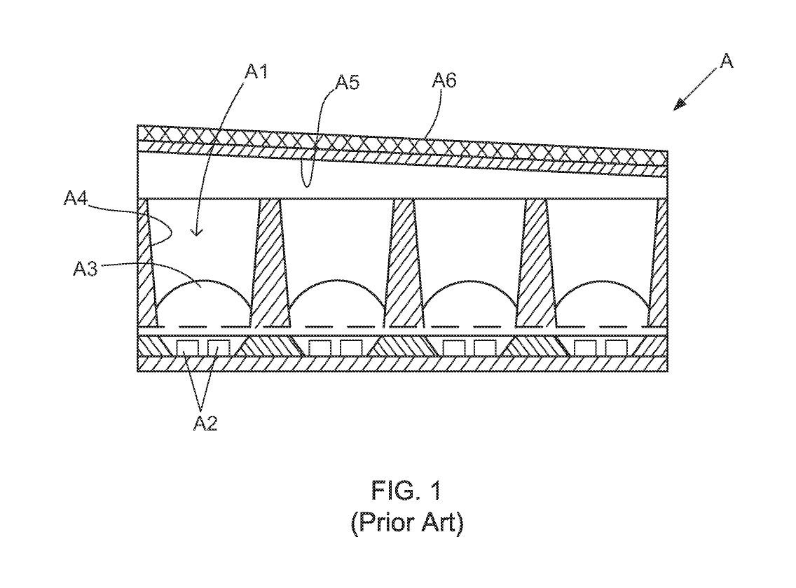

FIG. 2 is a cross-sectional view of a head-up display (HUD) in accordance with a first preferred embodiment of the present invention;

FIG. 3 is a schematic view of a head-up display (HUD) installed in a car in accordance with the first preferred embodiment of the present invention;

FIG. 4 is a cross-sectional view of a head-up display (HUD) in accordance with a second preferred embodiment of the present invention;

FIG. 5 is a cross-sectional view of a head-up display (HUD) in accordance with a third preferred embodiment of the present invention;

FIG. 6 is a cross-sectional view of a head-up display (HUD) in accordance with a fourth preferred embodiment of the present invention; and

FIG. 7 is a cross-sectional view of a head-up display (HUD) in accordance with a fifth preferred embodiment of the present invention.

### DETAILED DESCRIPTION OF THE PREFERRED EMBODIMENTS

To achieve the aforementioned objective and effects, the inventor of the present invention improved the conventional head-up display (HUD) and conducted extensive researches and experiments, and finally developed a head-up display (HUD) of the present invention. The first to fifth preferred embodiments are provided for illustrating the system structure and technical characterizes of the head-up display (HUD) of the present invention as follows.

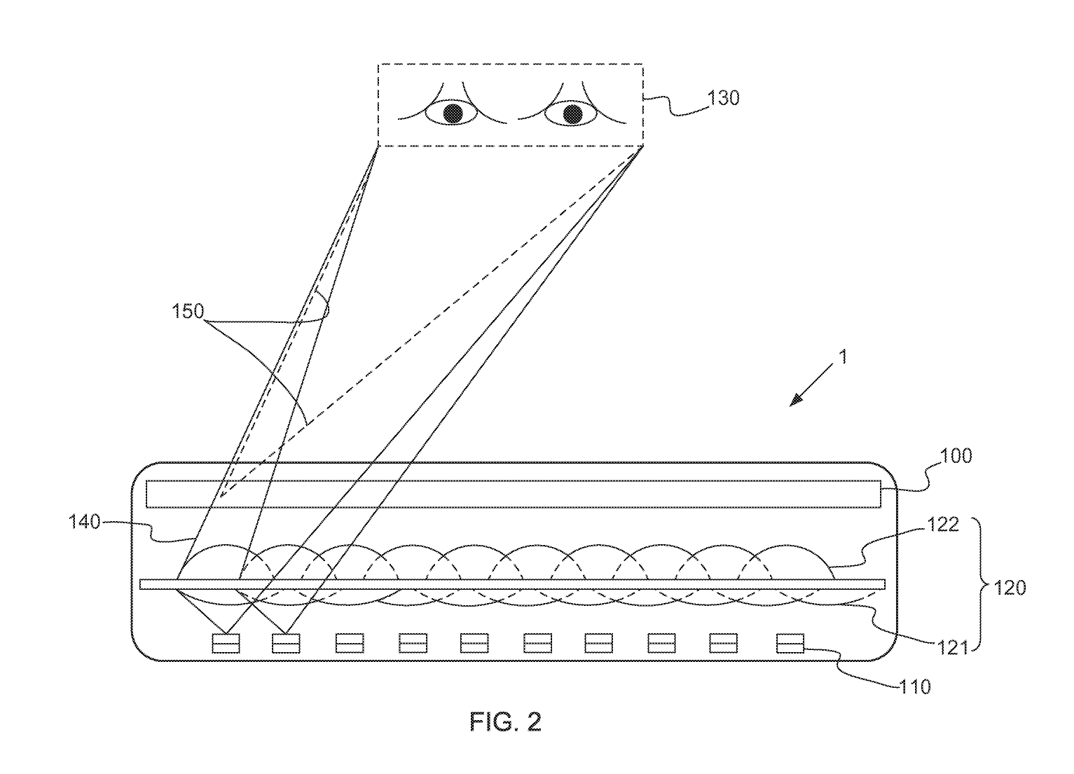

With reference to FIG. 2 for a cross-sectional view of a head-up display (HUD) in accordance with the first preferred embodiment of the present invention, the head-up display (HUD) 1 comprises an image display element 100, plurality of light sources 110 and a set of light guide components. In the first preferred embodiment, the set of light guide components is a group of light path modulation component arrays 120.

The image display element 100 is provided for forming an image to be displayed (not shown in the figure), wherein the image display element 100 is a Liquid Crystal Display (LCD), or an image display panel that requires an illumination light source can be used as a substitute in practical applications.

The plural light sources 110 are disposed on a side of the image display element 100, wherein each light source 110 can provide and project a light beam onto the image display element 100, so that the image to be displayed can be projected to the outside. Wherein, the type of the light sources 110 can be a light emitting diode, or a laser diode, an incandescent bulb, or a halogen bulb can be used as a substitute in practical applications.

The group of light path modulation component arrays 120 is disposed between the image display element 100 and the plurality of light sources 110, wherein the light path modulation component array 120 further comprises: a variable-picth 2D free-form surface lens array 121, disposed on a side of the light path modulation component array 120 and facing the plurality of light sources 110, and provided for converging the light beams of the plurality of light sources 110 into light beams with a smaller divergent angle; and a variable-picth 2D free-form cone array 122, disposed on a side of the light path modulation component array 120 and facing the image display element 100, and provided for deflecting the light beam to a viewing range 130 of a driver. In FIG. 2, the variable-picth 2D free-form surface lens array 121 and the variable-picth 2D free-form cone array 122 are disposed at positions with a height difference, and designed with an up-and-down structure of a broken line. An LED array is distributed under the light path modulation component array 120, and the distance between the LEDs is not necessary a constant, but it can be arranged according to the path of the light beam.

The path 140 is indicated by the solid line in the figure. After the light beam of each light source 110 is projected into the light path modulation component array 120, paths of all light beams are regulated by the light path modulation component array 120 and deflected and concentrated at the viewing range 130 of the driver to elevate the light intensity of each light beam, and each area of the image display element 100 is projected by a portion of light sources 110 to reduce the quantity of required light sources 110, so as to achieve an overall light and thin effect. In the dotted-line path 150 as shown in the figure, the light beam illuminating each pixel of the image display element 100 forms a conical distribution. In other words, each pixel on the image display element 100 can be seen within the driver's viewing range 130 only.

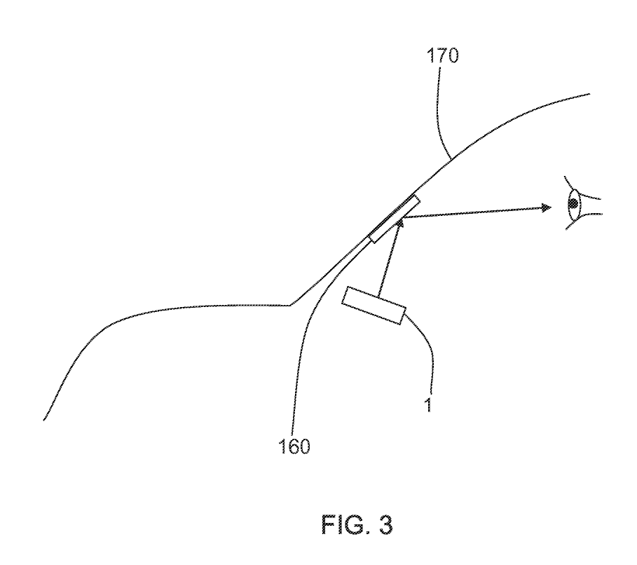

With reference to FIG. 3 for a schematic view of a head-up display (HUD) installed in a car in accordance with the first preferred embodiment of the present invention, the head-up display (HUD) 1 further comprises an image reflection mechanism 160 for receiving a light beam of the image to be displayed and reflecting the light beam of the image to be displayed to the driver's viewing range. Wherein, the image reflection mechanism 160 is installed on a front windshield 170, and it also can be selectively installed on a rear windshield, a rear mirror, a rearview mirror or a board surface capable of being operated and controlled to elevate or rotate and having a reflective property of at least a portion of the mirror surface.

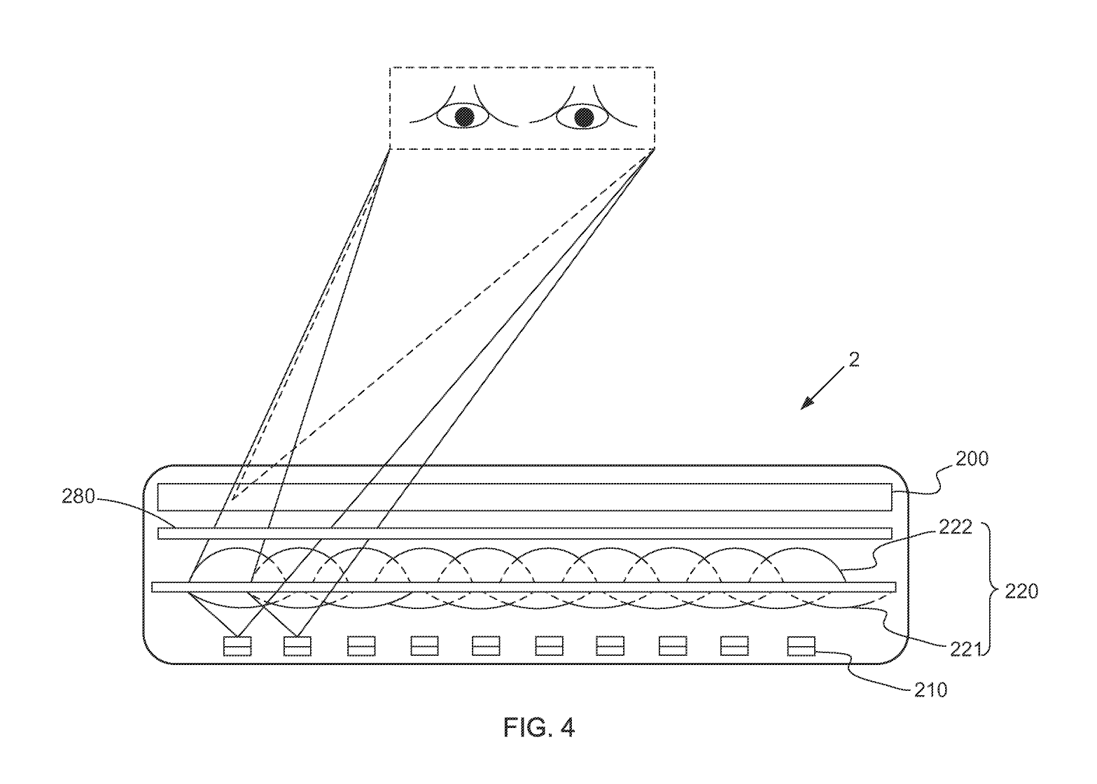

With reference to FIG. 4 for a cross-sectional view of a head-up display (HUD) in accordance with the second preferred embodiment of the present invention, the structure of the second preferred embodiment is substantially the same as the first preferred embodiment, except that a free space is formed between the light path modulation component array 120 and the image display element 100 of the first preferred embodiment, but a light guide structure 280 is installed between the light path modulation component array 220 and the image display element 200 of the second preferred embodiment to enhance the effect of projecting the light beam, such as revising or enlarging the image to be displayed to improve the viewing quality.

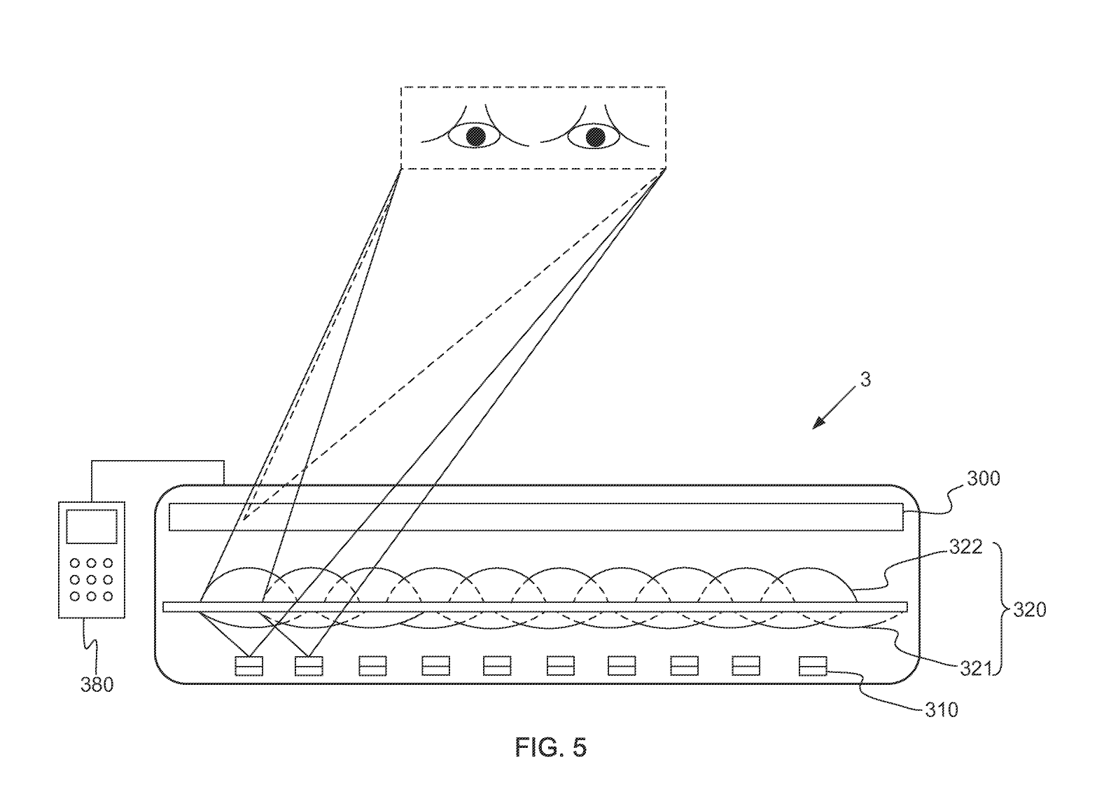

With reference to FIG. 5 for a cross-sectional view of a head-up display (HUD) in accordance with the third preferred embodiment of the present invention, the structure of the third preferred embodiment is substantially the same as the first preferred embodiment, except that the third preferred embodiment further comprises an operating interface 380 provided for the driver to operate and adjust the projecting position of the image to be displayed. Wherein, the operating interface 380 can be a touch screen, a selective press-button keyboard, a knob, a lever or any combination of the above.

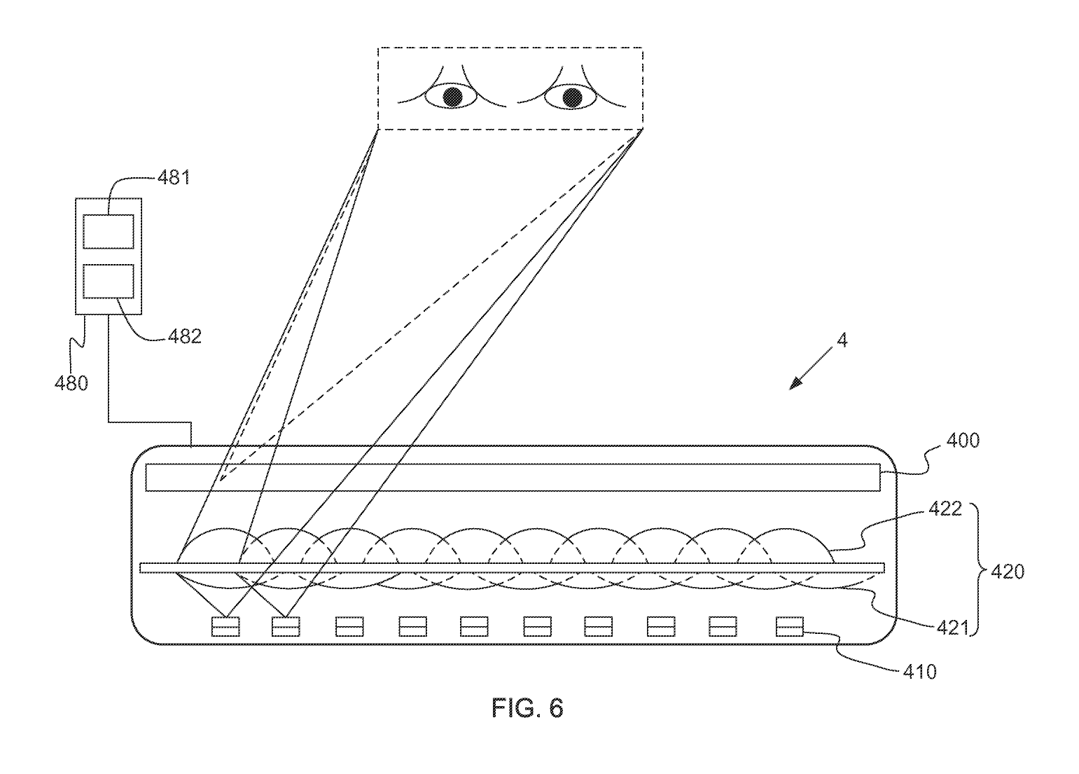

With reference to FIG. 6 for a cross-sectional view of a head-up display (HUD) in accordance with the second preferred embodiment of the present invention, the structure of the fourth preferred embodiment is substantially the same as the first preferred embodiment, except that the fourth preferred embodiment further comprise s an automatic control module 480 for automatically controlling and adjusting the projecting position of the image to be displayed. The automatic control module 480 comprises an eyeball capturing device 481 and an automatic control circuit 482, wherein the eyeball capturing device 481 is provided for capturing the eyeball position of the driver, and the automatic control circuit 482 is provided for adjusting the projection angle and position of the image to be displayed to achieve the best display effect.

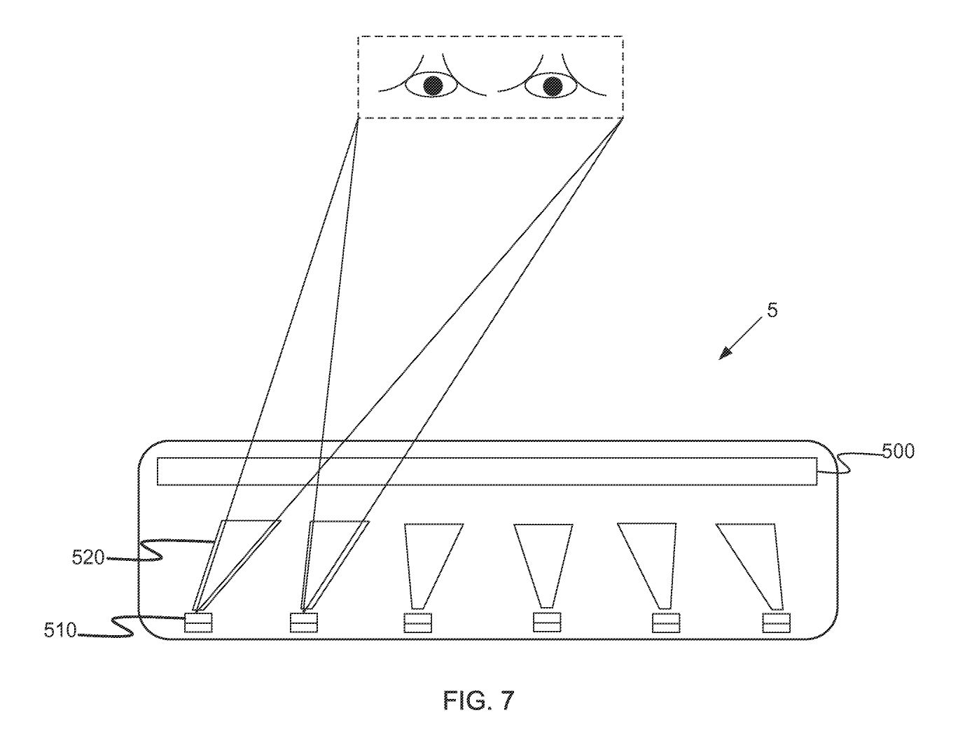

With reference to FIG. 7 for a cross-sectional view of a head-up display (HUD) in accordance with the second preferred embodiment of the present invention, the structure of the fifth preferred embodiment is substantially the same as the first preferred embodiment, except that the light guide component fifth preferred embodiment can be a group of light guide tube array 520, and the group of light guide tube array 520 can guide and project the light beams of the plurality of light sources 510 in a specific direction to achieve the effect of concentrating the light beam.

In summation of the description above, the present invention has the following advantages:

1. In the head-up display (HUD) of the present invention, after each light source projects its light beam to the set of light guide components, the paths of all light beams are adjusted by the light guide components to deflect and concentrate at a driver's viewing range to enhance the light intensity of each light beam and the overall utility.
2. In the head-up display (HUD) of the present invention, each area of the image display element is projected by one light source only, so that the quantity of required light sources can be reduced to achieve the overall light and thin effect.
3. The present invention just uses a small number of light sources to achieve the same light intensity as the prior art, so as to reduce the power consumption and the burden of the car.

In summation of the description above, the present invention improves over the prior art and complies with the patent application requirements, and thus is duly file for patent application. While the invention has been described by means of specific embodiments, numerous modifications and variations could be made thereto by those skilled in the art without departing from the scope and spirit of the invention set forth in the claims.

What is claimed is:

1. A head-up display (HUD), comprising:
an image display element, for forming an image to be displayed;
a plurality of light sources, disposed on a side of the image display element, and each light source providing and projecting a light beam onto the image display element, such that the image to be displayed can be projected to the outside; and
a set of light guide components, installed between the image display element and the plurality of light sources;
thereby, after each light source projects the light beam into the set of light guide components, paths of all light beams are regulated by the light guide components and deflected and concentrated at a viewing range of a driver to elevate the light intensity of each light beam, and each area of the image display element is projected by a portion of the light sources only, so as to decrease the quantity of required light sources and achieve an overall light and thin effect.

2. The head-up display (HUD) of claim 1, wherein the set of light guide components is one selected from a group of light guide tube arrays and a group of light path modulation component arrays.

3. The head-up display (HUD) of claim 2, wherein the group of light path modulation component arrays further comprises:
a variable-picth 2D free-form surface lens array, disposed on a side of the light path modulation component array and facing the plurality of light sources, and provided for converging the light beam of the plurality of light sources into a light beam with a smaller divergent angle; and
a variable-picth 2D free-form cone array, disposed on a side of the light path modulation component array facing the image display element, and provided for deflecting the light beam at the viewing range of the driver.

4. The head-up display (HUD) of claim 1, further comprising at least one light guide structure installed between the set of light guide components and the image display element to improve the effect of projecting the light beam.

5. The head-up display (HUD) of claim 1, wherein the plurality of light sources is one selected from the collection of a light emitting diode, a laser diode, an incandescent bulb and a halogen bulb.

6. The head-up display (HUD) of claim 1, wherein the image display element is one selected from the collection of a liquid crystal display (LCD) and an image display panel requiring an illumination light source.

7. The head-up display (HUD) of claim 1, further comprising at least one image reflection mechanism for receiving a light beam of the image to be displayed and reflecting the light beam of the image to be displayed to the viewing range of the driver.

8. The head-up display (HUD) of claim 7, wherein the image reflection mechanism is selectively installed at a front windshield, a rear windshield, a rear mirror, a rearview mirror and a board surface capable of being operated and controlled to elevate or rotate and having a reflective property of at least a portion of the mirror surface.

9. The head-up display (HUD) of claim 1, further comprising an operating interface provided for the driver to operate and adjust a projecting position of the image to be displayed.

10. The head-up display (HUD) of claim 1, further comprising an automatic control module including an eyeball capturing device and an automatic control circuit, and the eyeball capturing device being capable of capturing an eyeball position of the driver, and the automatic control circuit being used for adjusting the projection angle and the position of the image to be displayed to achieve the best display effect.
